(19) United States
(12) Patent Application Publication
(10) Pub. No.: US 2015/0242282 A1
(43) Pub. Date: Aug. 27, 2015

(54) MECHANISM TO UPDATE SOFTWARE PACKAGES

(71) Applicant: RED HAT, INC., Raleigh, NC (US)

(72) Inventor: Stephen Gallagher, Methuen, MA (US)

(73) Assignee: RED HAT, INC., Raleigh, NC (US)

(21) Appl. No.: 14/188,481

(22) Filed: Feb. 24, 2014

(51) Int. Cl. G06F 11/14

(52) U.S. Cl. CPC G06F 11/1433; G06F 11/1469; G06F 11/1451

(57) ABSTRACT

A system and a method are disclosed, including in response to a request to upgrade software stored in a file system, creating, by a processing device, a first snapshot of a file system, responsive to receiving a rollback request, creating a second snapshot of the file system, and rolling back the file system using the first snapshot.

### TECHNICAL FIELD

The present disclosure relates to computer systems, and more specifically to methods and systems to update software packages installed on computer systems.

### BACKGROUND

Computer systems typically include a file system which may further include system software and application software. The system software may have been installed by a system administrator for the operation of a computer system. The application software may have been installed by the system administrator and users for using the computer system to perform certain tasks. Both the system software and the application software may need to be updated in the event that a newer version of the software is released by the vendor. The process to update the software on the computer system may be referred to as software upgrade. Although software upgrades may be executed as planned without glitches, upgrade errors do occur from time to time. Sometimes, the errors may be detected during the process of the upgrade. At other times, the errors may be detected after the upgraded computer system has been used by users for a period of time. When upgrade errors are detected, it is a common practice to revert (or roll back) the computer system to a working state that was known prior to the upgrade. Therefore, states of the file system prior to the upgrade may need to be recorded in a backup storage so that the computer system may be rolled back to these prior states that are known to be correct.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates a computer system for updating software of a computer system.

FIG. 2 illustrates a backup system that backs up a computer system.

FIG. 3 illustrates a backup system that backs up a computer system according to an implementation of the disclosure.

FIG. 4 shows a flow diagram illustrating a method for reverting a software upgrade according to an implementation of the disclosure.

FIG. 5 shows a diagrammatic representation of a machine in the form of a computer system, in accordance with one example.

### DETAILED DESCRIPTION

When upgrade errors are detected either during a software upgrade or after the software upgrade of a computer system, it is a common practice to roll back the computer system to a previously known working state. For example, just prior to the upgrade of the software, a snapshot of the file system of the computer system may be captured by a backup tool and stored in a storage. A snapshot is a copy of the file system from which the file system may be restored to the time when the snapshot was captured. The snapshot may include a collection of software installed in the computer system and files contained in the file system. The snapshot may be referenced according to a restore point. A restore point may be a data record including a pointer to the saved snapshot and a time at which the snapshot was taken. Subsequently, when upgrade errors are detected, an administrator or a user of the computer system may restore the files system of the computer system according to the restore point using the captured snapshot stored in the storage.

While the restoration process (or rollback process) can restore the file system of the computer system to a known stable state prior to the upgrade, the restoration process does not typically preserve the state of the file system after the upgrade or the data acquired after the upgrade. Since the upgrade errors may be detected after users had used the computer system for a period of time, the file system of the computer system after the upgrade may contain useful information. For example, after the upgrade, the users may have created and/or updated certain files that the users may want to preserve rather than losing over the restoration process. Moreover, the file system after the upgrade may contain useful information for determining the reasons of a faulty (e.g., improper or incomplete) upgrade in view of the data collected after the upgrade. Therefore, it may be helpful to preserve information acquired after an upgrade in the event of a faulty upgrade.

Implementations of the disclosure may include a method. The method may include in response to a request to upgrade software stored in a file system, creating, by a processing device, a first snapshot of a file system, responsive to receiving a rollback request, creating a second snapshot of the file system, and rolling back the file system using the first snapshot.

Implementations of the disclosure provide systems and methods that preserve not only the restore points prior to a software upgrade, but also the accumulated updates of the file system after the upgrade. Snapshots may be taken after the upgrade and preserved as restore points. In the event that errors caused by the upgrade are detected, a further snapshot of the file system may be taken as a rollback point just prior to the initiation of the rollback process. The rollback point is a data recording that contains a link to a snapshot that is captured at the beginning of a rollback process to retain access to the data acquired during the time period from an upgrade to a reversion. The snapshot taken at the rollback point may be subsequently mounted as a file directory accessible by users using the rollback point.

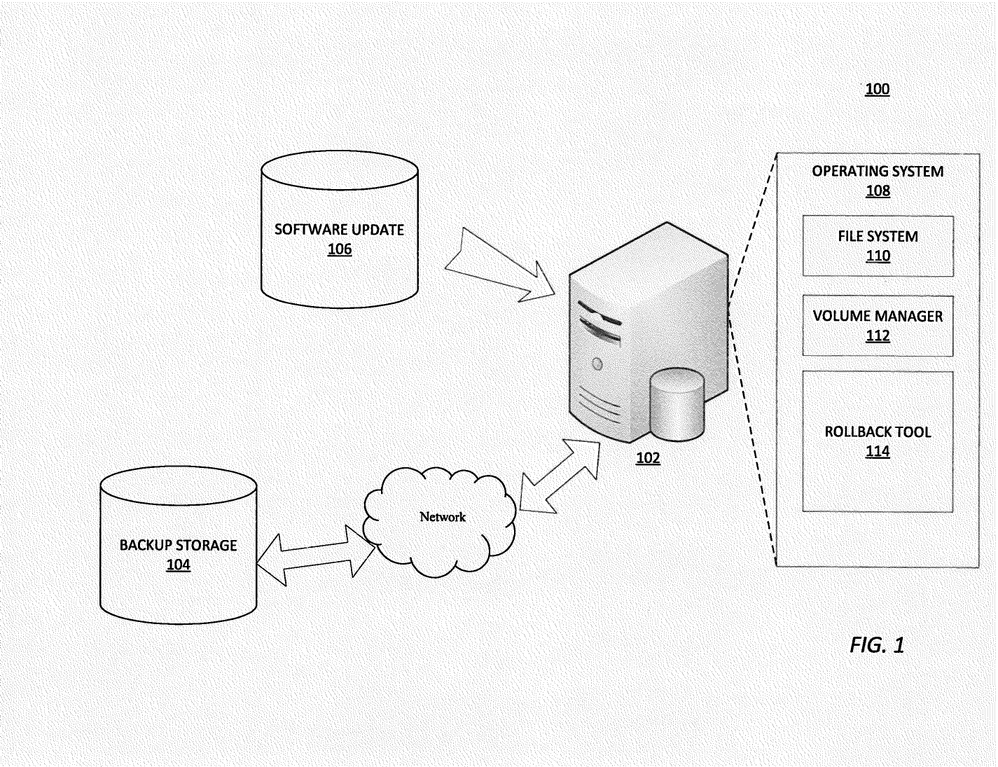

FIG. 1 illustrates a system 100 for updating software for a processing device (such as a computer system). Referring to FIG. 1, system 100 may include a processing device 102, a backup storage device 104 that is part of the processing device or alternatively is coupled to the processing device 102 through a communication network, and a repository of software updates 106. Processing device 102 may include hardware components such as processors, storage devices, and peripheral devices that operate under the control of system software and application software. The system software may include an operating system 108 which may schedule and coordinate operations of the hardware components of the processing device 102.

The operating system 108 may further include a file system 110, a volume manager 112, and a rollback tool 114. The file system may logically map the physical blocks in storage devices to formats that may be recognizable by system software and application software. In practice, system software and application software are also installed on the file system 110. Further, users of processing device 102 may generate documents and data that are also stored on the file system 110.

File system 110 may hierarchically organize documents and data stored therein. For example, the documents may be stored in the file system according to a tree structure. Each node of the tree structure may represent a folder (or a directory), and the child nodes of the node may be sub-folders (sub-directories) or documents.

Volume manager 112 is a module in operating system 108 that is capable of taking a snapshot of the file system 110 (e.g., at the direction of a user or according to a schedule). A snapshot of file system 110 includes the copy of file system 110 at a particular point in time from which the processing device 102 may restore the file system at a later time. The captured snapshot of the file system 110 may be stored in a backup storage device 104 through the communication network. These stored snapshots may be referenced according to restore points recorded at the times at which the snapshots are captured.

Users may issue instructions to volume manager 112 via a rollback tool 114 which may be shell level commands. Thus, a user may issue commands via the rollback tool 114 to take a snapshot of the file system. Alternatively, volume manager 112 may be programmed to take snapshots of the file system in accordance with certain triggers. For example, snapshots may be taken at a fixed time intervals (hourly, daily, or monthly). Snapshots may also be taken in response to an impending event such as the event of an upgrade. Volume manager 112 may keep a record of restore points that are associated with snapshots taken. In this way, processing device 102 may be reliably restored to states according to the restore points and the associated snapshots.

Both system software and application software may be installed on the processing device and upgraded when new releases of the system software and application software are available. The software update (including new installation or upgrade) may be staged at repository 106 before being installed. Repository 106 may reside in a remote server accessible via communication network (such as the Internet) or may be retrievable from a local storage (such as local hard drives or media drives). Software updates to processing device 102 may cause changes in the content of file system 110. To be safe, a restore point may be created just before a software update.

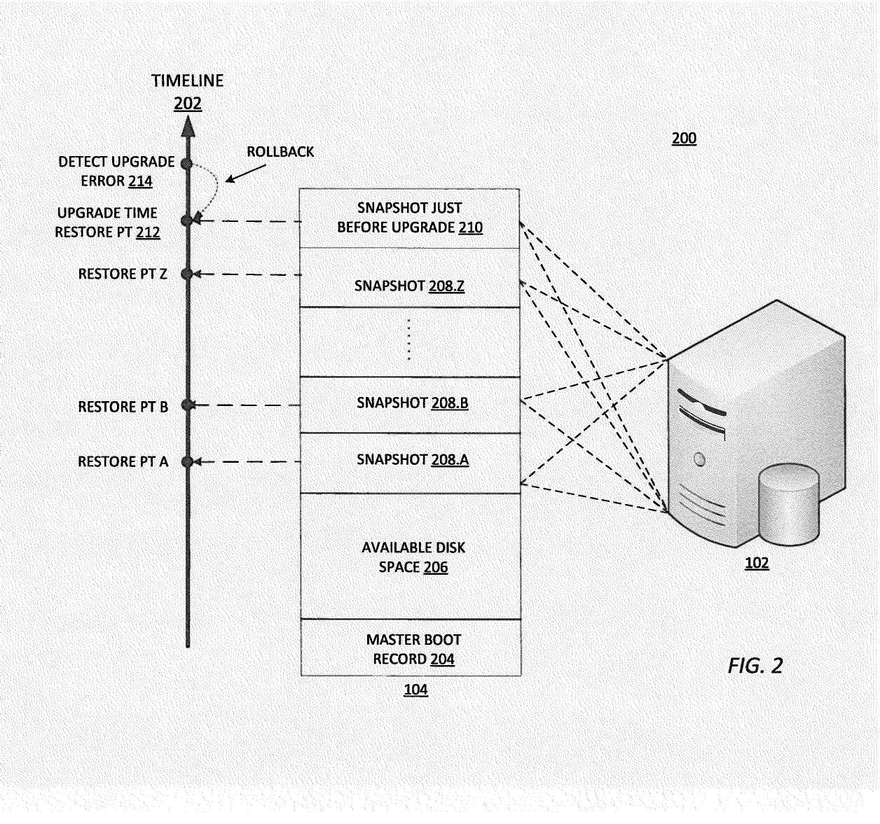

FIG. 2 illustrates a backup system 200 that backs up a computer system. Referring to FIG. 2, a backup storage device 104 may be used to store snapshots of a file system of processing device 102. For the purpose of illustration, a time-line 202 shows events that occur according to time. Backup storage device 104 may include a master boot record 204, available disk space 206, and blocks that store snapshots 208.A-208.Z, and a block to store a snapshot taken just 210.

Master boot record 204 may be a special section of the storage space of the backup storage device 104 and may contain information as to how the storage space is logically partitioned. Further, master boot record 204 may include an executable code for the installation of an operating system. Thus, if the operating system of the processing device 102 is corrupted, it still can be restored from master boot record 204. Backup storage device 104 may further include partitions that may be used to store snapshots. As shown in FIG. 2, restore points A-Z may be linked to snapshots 208.I through 208.Z that may be captured according to snapshot triggers. Snapshots 208.A-208.Z may be used to restore the processing device 102 to states at restore points A-Z.

In the event that software in processing device 102 is to be upgraded at an upgrade time, prior to happening of the upgrade, a snapshot 210 of the file system of processing device 102 may be taken and recorded as restore point 212. Snapshot 210 may capture the state of processing device 102 prior to the software grade. This state may be the last known working state of processing device 102. After snapshot 210 is captured, users may continue using processing device 102 and generate updated files in the file system of processing device 102.

In the event that one or more upgrade errors are detected at time 214, a user may decide to roll back processing device 102 to restore point 212. The upgrade errors are errors caused by the upgraded software. A rollback tool 114 may be built on top of volume manager 112. The user may issue instructions through the rollback tool 114 to retrieve snapshot 210 which is linked to restore point 212. The user may further use the rollback tool 114 to restore the processing device 102 to the previous state at restore point 212 which is a known working state.

Although the restoration system as shown in FIG. 2 may restore processing device 102, it does not preserve data and information generated and stored in the file system between upgrade time and upgrade error detection—or information stored on the file system subsequent to the upgrade. The data and information generated in this period of time may be useful to the user.

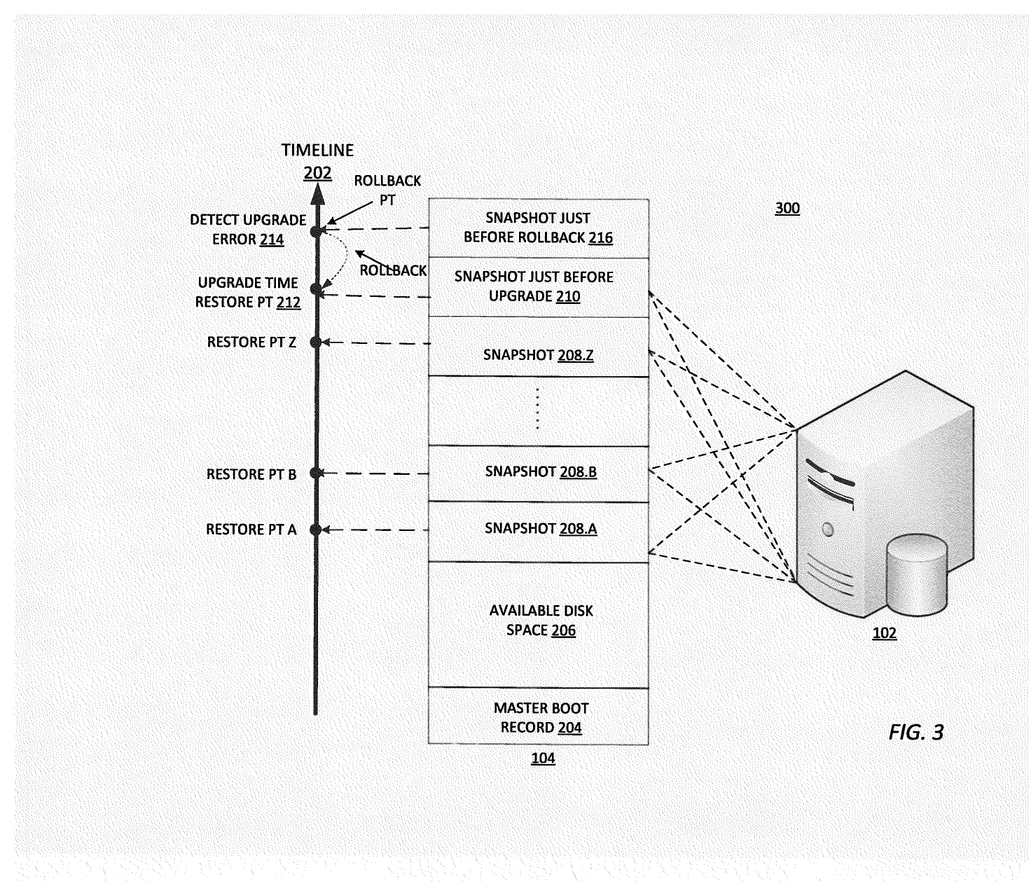

FIG. 3 illustrates a backup system 300 that backs up a computer system according to an implementation of the disclosure. As shown in FIG. 3, upon the detection of upgrade errors at time 214 and prior to the rollback, the rollback tool 114 may take a snapshot 216 of the file system of processing device 102. Snapshot 216 may capture all data and information of the file system at a rollback point at time 214, thereby including all data and information that were generated after the upgrade time. The rollback tool 114 may then associate the rollback point to snapshot 212. Subsequently, the file system of the processing device may be rolled back to a known restore point such as restore point 212 (or any one of restore points 208.A through 208.Z). After the processing device 102 is restored to a state according to restore point 212, the rollback tool may mount a directory containing the snapshot referenced by the rollback point to a file directory that is accessible so that files in the mounted the file directory may be retrieved.

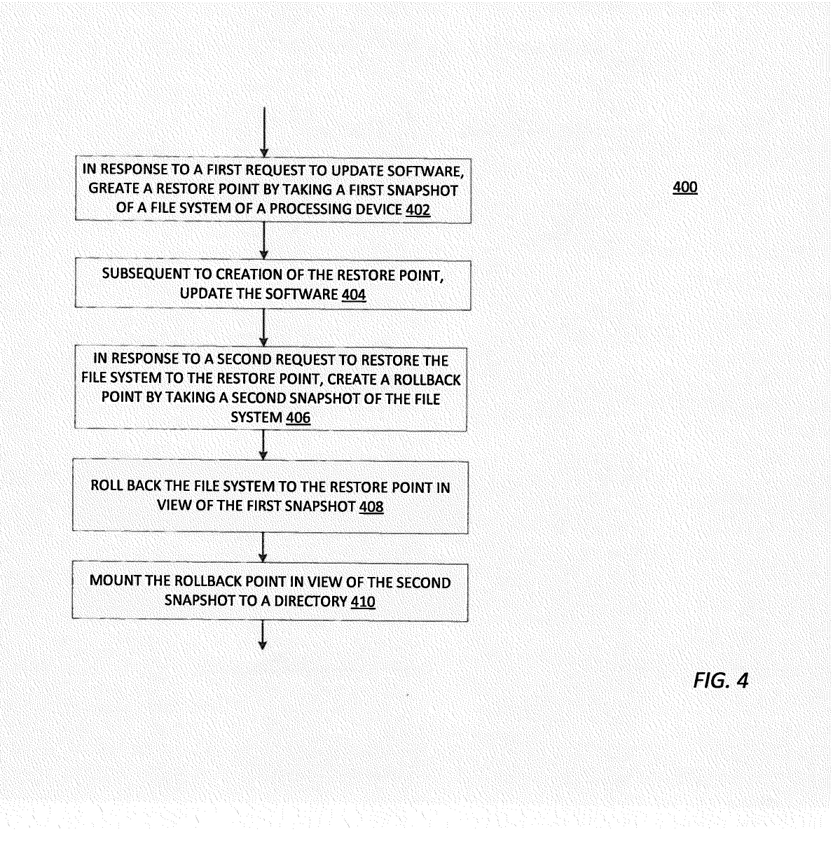

FIG. 4 shows a flow diagram illustrating a method 400 for reverting a software upgrade according to an implementation of the disclosure. Method 400 may be performed by a processing logic that may include hardware (e.g., circuitry, dedicated logic, programmable logic, microcode, etc.), software (e.g., instructions run on a processing device to perform hardware simulation), or a combination thereof. In one example, method 400 may be performed by the rollback tool 114 built on volume manager 112 of operating system 108 as shown in FIG. 1.

For simplicity of explanation, methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

The processing logic may be a rollback tool executed on a processor. At 402, the processing logic may receive a request to upgrade software of a processing device. The software upgrade may include system or application software upgrade. Upgrade utility such as Yum may be used to facilitate the upgrade. In response to the request of upgrading, the processing logic may create a restore point using a rollback tool (built on a logical volume manager (LVM) that controls the storage device) by taking a first snapshot of the file system of the processing device. The restore point may include a LVM tag indicating an active partition in the LVM at which the first snapshot is stored and time when the first snapshot is taken. From the restore point, the processing device may be restored to a state of the time when the first snapshot is taken.

At 404, subsequent to the creation of the restore point, software of the processing device may be upgraded with the upgrade utility. Thereafter, users of the processing device may continue using the upgraded processing device. The usage of the processing device may generate new data and information in the file system of the processing device.

At 406, certain errors occurred to the upgraded processing device may be detected. These errors may be so serious that the processing device may need to roll back the state of the file system of the processing device to a time prior to the upgrade. In response to a request to roll back the state of the processing device, the processing logic may present to the user a list of restore points that have been created prior to the upgrade. These restore points are known to be correct. The processing logic may display the time when the processing logic created these restore points. Additionally, the processing logic may display disk space that is available on the backup system and disk space that each of the restore point would have taken when the corresponding snapshot is retrieved and extracted to the file system. The processing device may also provide the option to remove restore points in the event that there is not enough disk space. In one implementation, the restore point that was created in conjunction with the upgrade to restore the processing device to the state just prior to the upgrade may be selected.

In response to the selection to restore the processing device, the processing logic may take a snapshot of the file system of the processing device to create a rollback point. The rollback point may be a data record including time when the snapshot was taken and a link that links to the snapshot. In one implementation, the rollback point may point to an inactive disk partition stored thereon the one or more representations of the accumulated updates to the file system since the upgrade. The inactive partition may be become active after a mount by the processing logic. The snapshot of the rollback point may be associated with a universal unique identification (UUID) that can be used to reference the mounted partition. Subsequent to the creation of the rollback point, the processing logic may move the universal unique identification (UUID) of the activated partition of the file system to point to the restore point.

At 408, the processing device may be rolled back to the restore point. In one implementation, the processing device may be rebooted. Upon restart, the processing device is rolled back to the state of the restore point.

At 410, after the rollback, the processing logic may mount the rollback point to a file directory of the file system to make the data and information of the rollback point available to the user. In one implementation, the processing logic (e.g., at user's direction) may exact extract data from the file directory. The processing logic may retrieve the stored file difference and calculate a complete file for the user. The complete file may include all updated files from the upgrade to the time of rollback.

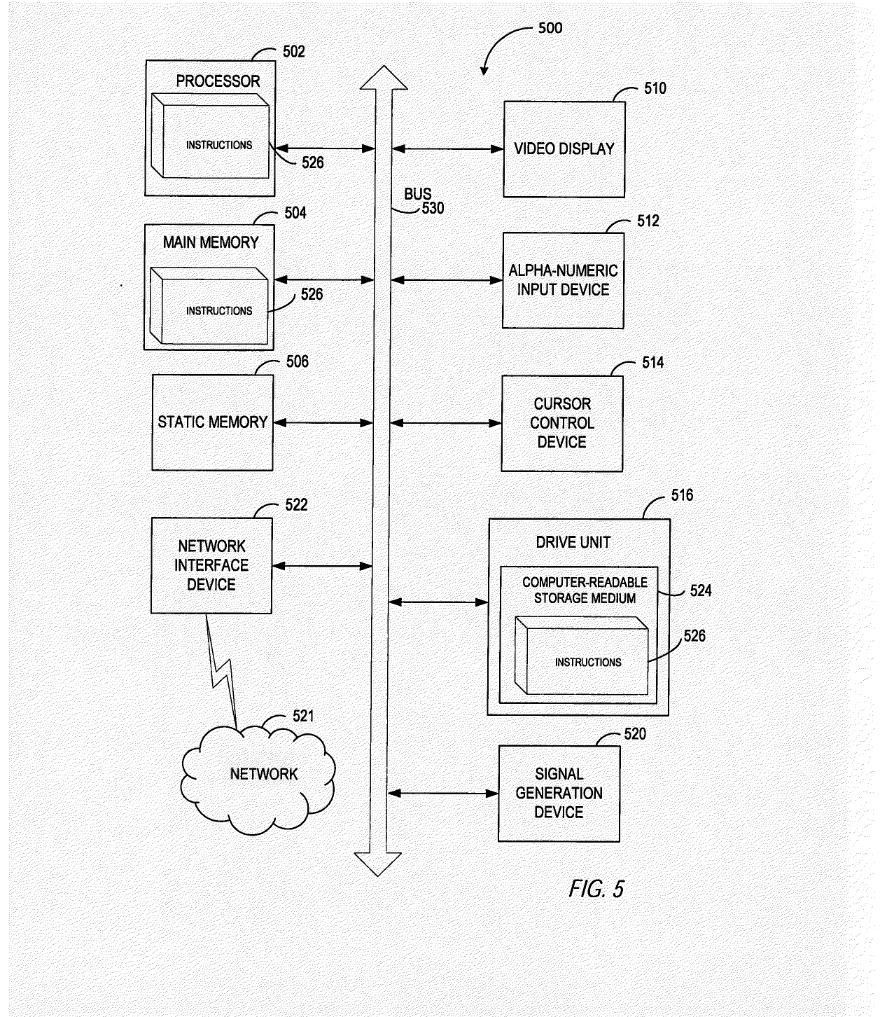

FIG. 5 depicts a diagrammatic representation of a machine in the form of a computer system 500 within which a set of memory instructions 526, for causing the machine to perform any one or more of the methodologies discussed herein, may be executed. In alternative examples, the machine may be connected (e.g., networked) to other machines in a Local Area Network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The computer system 500 includes a processor 502 (e.g., a processing device), a main memory 504 (e.g., read-only memory (ROM), flash memory, dynamic random access memory (DRAM) such as synchronous DRAM (SDRAM), etc.), a static memory 506 (e.g., flash memory, static random access memory (SRAM), etc.), and a secondary memory 516 (e.g., a data storage device), which communicate with each other via a bus 530.

The processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. The processor 502 may also be one or more special-purpose processing devices such as an application specific integrated circuit (ASIC), a field programmable gate array (FPGA), a digital signal processor (DSP), network processor, or the like.

The computer system 500 may further include a network interface device 522. The network interface device may be in communication with a network 521. The computer system 500 also may include a video display unit 510 (e.g., a liquid crystal display (LCD), a touch screen, or a cathode ray tube (CRT)), an alphanumeric input device 512 (e.g., a keyboard), a cursor control device 514 (e.g., a mouse), and a signal generation device 520 (e.g., a speaker).

The secondary memory 516 may include a computer-readable storage medium (or more specifically a non-transitory computer-readable storage medium) 524 on which is stored one or more sets of instructions 526 for the computer system 100 representing any one or more of the methodologies or functions described herein. The instructions 526 for the computer system 100 may also reside, completely or at least partially, within the main memory 504 and/or within the processor 502 during execution thereof by the computer system 500, the main memory 504 and the processing device 502 also constituting computer-readable storage media. The instructions 526 for the computer system 100 may further be transmitted or received over a network via the network interface device 522.

While the computer-readable storage medium 524 is shown in an example to be a single medium, the term “computer-readable storage medium” should be taken to include a single medium or multiple media (e.g., a centralized or distributed database, and/or associated caches and servers) that store the one or more sets of instructions 526. The term “computer-readable storage medium” shall also be taken to include any medium that is capable of storing or encoding a set of instructions for execution by the machine that cause the machine to perform any one or more of the methodologies of the disclosure. The term “computer-readable storage medium” shall accordingly be taken to include, but not be limited to, solid-state memories, and optical and magnetic media.

Some portions of the detailed descriptions above are presented in terms of symbolic representations of operations on data bits within a computer memory. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “configuring,” “associating,” “executing,” “adjusting,” “sending,” “receiving,” “determining,” “transmitting,” “identifying,” “specifying,” “granting,” “accessing,” “assigning,” “detecting,” and “requesting,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may be a general purpose computer system selectively programmed by a computer program stored in the computer system. Such a computer program may be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The descriptions and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear as set forth in the description below. In addition, the disclosure is not described with reference to any particular programming language. It will be appreciated that a variety of programming languages may be used to implement the teachings of the disclosure as described herein.

It is to be understood that the above description is intended to be illustrative, and not restrictive. Many other examples will be apparent to those of skill in the art upon reading and understanding the above description. Although the disclosure has been described with reference to specific examples, it will be recognized that the disclosure is not limited to the examples described, but can be practiced with modification and alteration within the spirit and scope of the appended claims. Accordingly, the specification and drawings are to be regarded in an illustrative sense rather than a restrictive sense. The scope of the disclosure should, therefore, be determined with reference to the appended claims, along with the full scope of equivalents to which such claims are entitled.

What is claimed is:

1. A method comprising:
creating, by a processing device, a first snapshot of a file system;
responsive to receiving a rollback request, creating a second snapshot of the file system; and
rolling back the file system using the first snapshot.

2. The method of claim 1, further comprising:
in response to rolling back the file system, mounting the second snapshot to a file system directory;
restoring at least one file of the second snapshot from the file system directory.

3. The method of claim 2, further comprising:
retrieving the at least one one file from the file directory.

4. The method of claim 2, further comprising:
deleting the file system directory.

5. The method of claim 1, wherein the second snap shot is created responsive to a software upgrade.

6. The method of claim 1, wherein the second snapshot contains one or more files of the file system.

7. The method of claim 1, wherein the second snapshot contain differences from the first snapshot of the file system.

8. The method of claim 1, wherein the first and second snapshots are stored in a backup storage device coupled to the file system.

9. An apparatus comprising:
a storage device to store a file system; and
a processing device communicably coupled to the storage device to:
create, by the processing device, a first snapshot of a file system;
responsive to receiving a rollback request, create a second snapshot of the file system; and
roll back the file system using the first snapshot.

10. The apparatus of claim 9, wherein the processing device is further to
responsive to rolling back the file system, mount the second snapshot to a file system directory;
restore at least one file of the second snapshot from the file system directory.

11. The apparatus of claim 10, wherein the processing device is further to retrieve the at least one one file from the file directory.

12. The apparatus of claim 10, wherein the processing device is further to delete the file system directory.

13. The apparatus of claim 9, wherein the second snap shot is created responsive to a software upgrade.

14. The apparatus of claim 9, wherein the second snapshot contains one or more files of the file system.

15. The apparatus of claim 9, wherein the second snapshot contain differences from the first snapshot of the file system.

16. The apparatus of claim 9, wherein the first and second snapshots are stored in a backup storage device coupled to the file system.

17. A non-transitory computer readable storage medium including instructions that, when executed by a processing device, cause the processing device to perform operations comprising:
creating, by the processing device, a first snapshot of a file system;
responsive to receiving a rollback request, creating a second snapshot of the file system; and
rolling back the file system using the first snapshot.

18. The non-transitory computer readable storage medium of claim 17, wherein the operations further comprise:
responsive to rolling back the file system, mounting the second snapshot to a file system directory;
restore at least one file of the second snapshot from the file system directory.

19. The non-transitory computer readable storage medium of claim 17, wherein the second snap shot is created responsive to a software upgrade.

20. The non-transitory computer readable storage medium of claim 17, wherein the second snapshot contain differences from the first snapshot of the file system.
